(19) United States
(12) Patent Application Publication
(10) Pub. No.: US 2014/0179449 A1
(43) Pub. Date: Jun. 26, 2014

(54) CRIMPLESS BOOT

(71) Applicant: GKN Driveline North America, Inc., Auburn Hills, MI (US)

(72) Inventors: Michael Miller, White Lake, MI (US); Eric J. LaMothe, Goodrich, MI (US); Sam Junior D'Angelo, Shelby Township, MI (US)

(21) Appl. No.: 13/721,589

(22) Filed: Dec. 20, 2012

(51) Int. Cl. F16D 3/84

(52) U.S. Cl. CPC F16D 3/845
USPC 464/175

(57) ABSTRACT

A constant velocity joint may include a shaft and a boot assembly. The boot assembly may include a boot having a boot neck. The boot neck may include a boot lip. A shaft may be rotationally coupled to a housing and may define a shaft groove. An attachment mechanism may be integrated within the boot neck. The shaft groove may be configured to receive the boot lip and the attachment mechanism may exert a radial force on the groove to secure the boot neck to the shaft.

### TECHNICAL FIELD

Described herein is a constant velocity joint and an improved boot therefore.

### BACKGROUND

Constant velocity joints (CV joints) are common components in vehicles. CV joints are often employed where transmission of a constant velocity rotary motion is desired or required. CV joints are typically greased or otherwise lubricated for the life of the component. The joints are preferably sealed to retain the grease or lubricant inside the joint while keeping contaminants and foreign matter, such as water and dirt, out of the joint. Moreover, a sealing boot, which may be made of rubber, thermoplastic, silicone material, or the like, usually encloses portions of the CV joints. The boot provides a flexible barrier to retain the grease in the joint so as to reduce friction and extend the life of the joint.

Boots come in a variety of types such as internal rolling diaphragm (IRD) and external rolling diaphragm (ERD). Traditional boots may be connected to the shaft of a CV joint via crimping. Centrifugal forces and friction created by the internal components of the CV joint result in expansion or ballooning of the flexible boot. These forces are also created as a result of pressure created from heat and high speed operation. The constant expansion and contraction of the flexible member results in fatigue, wear, and eventual failure of the boot. Further, during manufacturing, the boot may be crimped or clamped to the shaft, creating an additional step and the need for additional parts in the manufacturing process. Accordingly, there is a need for a durable seal between the boot and the shaft, as well as an efficient method of securing the boot to the shaft.

### BRIEF DESCRIPTION OF THE DRAWINGS

FIG. 1 illustrates a side cross-sectional view of an exemplary constant velocity joint assembly and attached boot assembly;

FIG. 2 illustrates an enlarged view of encircled area A of FIG. 1 of an exemplary attachment mechanism, flexible boot and shaft region;

FIG. 3 illustrates a perspective view of the attachment mechanism of FIG. 2;

FIG. 4 illustrates another enlarged view of an exemplary attachment mechanism, flexible boot and shaft region;

FIG. 5 illustrates a perspective view of the attachment mechanism of FIG. 4;

FIG. 6 illustrates another enlarged view of an exemplary attachment mechanism, flexible boot and shaft region;

FIG. 7 illustrates a perspective view of the attachment mechanism of FIG. 6;

FIG. 8 illustrates a side elevation view of the attachment mechanism of FIG. 7;

FIG. 9 illustrates another enlarged view of an exemplary attachment mechanism, flexible boot and shaft region;

FIG. 10 illustrates a partial end view of the attachment mechanism, boot and shaft of FIG. 9;

FIG. 11 illustrates a perspective view of the attachment mechanism of FIG. 9;

FIG. 12 illustrates a side elevation view of the attachment mechanism of FIG. 11;

FIG. 13 illustrates another enlarged view of an exemplary attachment mechanism, flexible boot and shaft region;

FIG. 14 illustrates a perspective view of the attachment mechanism of FIG. 13;

FIG. 15 illustrates another enlarged view of an exemplary attachment mechanism, flexible boot and shaft region; and

FIG. 16 illustrates another enlarged view of an exemplary attachment mechanism, flexible boot and shaft region.

### DETAILED DESCRIPTION

Referring to the drawings, a constant velocity joint (CV Joint) is shown. It should be noted that all types of CV joints, such as plunging tripods, fixed ball joints, etc., may be used with the present disclosure. Advantages realized by the disclosure may be applied to substantially all types of constant velocity joints, and, therefore, the disclosure should not be limited to the illustrated embodiments. Further, references in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.”

Disclosed herein is a CV joint having a boot and a shaft connected via a groove defined by the shaft and a lip of the neck of the boot. An attachment mechanism may be disposed with the neck to maintain the neck in the groove of the shaft. The attachment mechanism may be at least partially overmolded into at least a portion of the neck before the boot is placed and attached to the shaft. Thus, the attachment mechanism may be integral with the boot neck and the need to attach the boot to the shaft via a separate and additional mechanical clamp or other traditional crimping method is eliminated. In removing the traditional clamping and/or crimping step, the manufacturing process is more seamless and less cumbersome. By eliminating this step, the need for clamping parts, as well as clamping and crimping machinery is eliminated. Moreover, the problem of improper placement of the boot clamp when clamping and losing the boot clamp, which often occur during the manufacturing, are also eliminated.

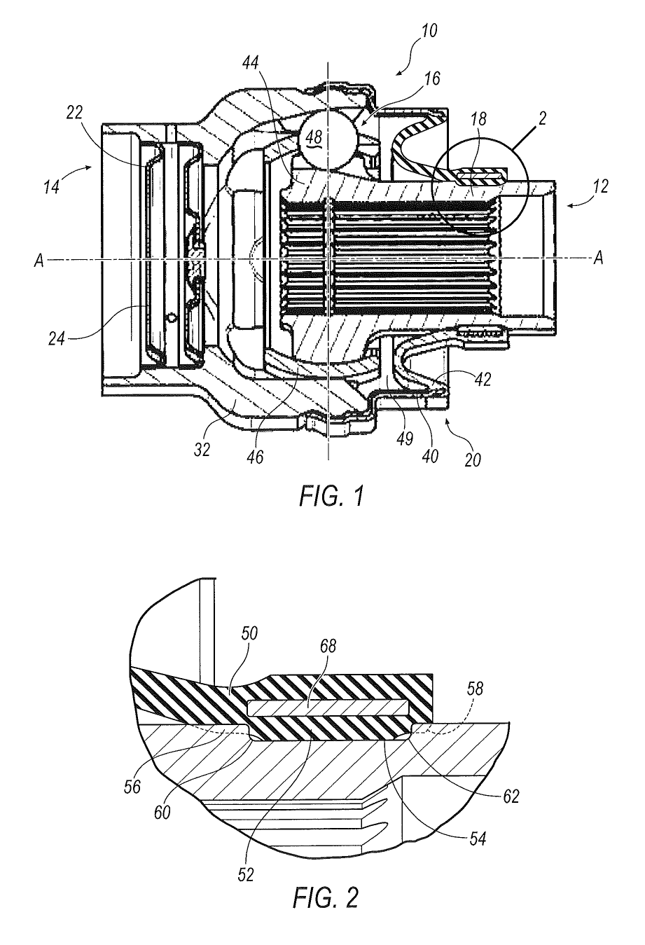

Referring to FIG. 1, a CV joint 10 having a central axis A-A is illustrated according to an embodiment. The CV joint 10 includes a driving end 12 and a driven end 14. The CV joint 10 further includes a joint assembly 16 coupled to a shaft 18 with a boot cover assembly 20 connected therebetween. The CV joint 10 may further include a grease cover 22 that seals the driven end 14. The boot cover assembly 20 may include a metal cover 40 and a flexible CV joint boot 42. The boot cover assembly 20 and the grease cover 22 may protect the moving parts of the CV joint 10 during operation by retaining the grease or lubricant inside the joint 10 while keeping contaminants and foreign matter, such as water and dirt, out of the joint assembly 16.

The joint assembly 16 may include a cage 46, a first rotational member or outer race 32, a second rotational member or inner race 44, and a plurality of balls 48. The cage 46 retains the balls 48 between the first rotational member 32 and the second rotational member 44 in a generally equally spaced circumferential orientation. The shaft 18 is splined to second rotational member 44 to allow axial movement therebetween.

Collectively, at least the shaft 18, the boot cover assembly 20, the first rotational member 32, and the grease cover 22, form a joint chamber 49. The joint chamber 49 contains grease or other lubricants (not shown) for lubrication between the cage 46, the first rotational member 32, the second rotational member 44, and the balls 48. During operation of the CV joint 10, lubricant contained within joint chamber 49 will generally be drawn outwards toward the first rotational member by centrifugal forces generated by the spinning of the CV joint 10. The boot cover assembly 20 may help prevent grease and other lubricant from leaving the chamber 49.

The boot 42 of the boot assembly 20 may include a boot neck 50 (see, e.g. FIG. 2) at a distal end of the boot 42. The boot neck 50 may include a lip 52 on an inner side of the neck 50. The lip 52 may extend radially inward from the inside of the boot neck 50. The lip 52 may form a proximal lip end 56 and a distal lip end 58. Each of the ends 56, 58 may slope inward towards the center of the lip at a gradual decline. The sloping of proximal lip end 56 may facilitate the sliding of the boot 42 over the shaft 18 or inner race 44. The shaft 18, or inner race 44, may define a groove 54 at the driving end 12. The groove 54 may extend radially round the shaft 18 and have a proximal wall 60 and a distal wall 62. Each of the groove walls 60, 62 may form an approximately ninety degree angle with the groove 54. Alternatively, the proximal wall 60 may slope gradually inward towards the groove 54 while the distal wall 62 may form an approximately ninety degree angle.

The groove 54 may be configured to receive the lip 52 of the boot neck 50 and provide for axial placement of the boot 42 relative to the shaft 18 or inner race 44. For example, the boot 42 may be slid over the shaft 18 or inner race 44 and locked to the shaft 18 when the lip 52 is received by the groove 54. The proximal lip end 56 may help facilitate the sliding of the lip 52 into the groove 54. Moreover, the distal lip end 58 may abut the distal groove wall 62, preventing the boot neck 50 from sliding past the groove 54. Thus, the distal groove wall 62 may help maintain the lip 52 within the groove 54 by acting as a stop against the distal lip end 58. The proximal groove wall 60 may abut the proximal lip end 56 to further secure the lip 52 within the groove 54 at the proximal end. Thus, the lip 52 may fit securely within the groove 54 via a frictional engagement.

In one exemplary configuration, the walls 60, 62 of the groove 54 may become integral with the lip ends 56, 58. As the lip 52 is located within the groove 54, the lip ends 56, 58 may be forced between the groove walls 60, 62. The lip ends 56, 58 may conform, at least partially, to the shape of the groove walls 60, 62. For example, the groove walls 60, 62 may form approximately ninety degree angles while the lip ends 56, 58 may form an inclined slope. The sloped lip ends 56, 58 may conform and mold with the groove walls 60, 62, thus creating another frictional and integral fit between the lip 52 and the groove 54. Additionally or alternatively, the groove walls 60, 62 may also conform to the sloped lip ends 56, 58.

The boot neck 50 may further be secured in the groove 54 via an attachment mechanism 68. The attachment mechanism 68 may be overmolded into the boot neck 50 and be configured to exert a compressive force at the boot neck 50 into the shaft groove 54. Thus, once the boot neck 50 has been slid onto the shaft 18 or inner race 44 and held in place by the interconnection of lip 52 and groove 54, the attachment mechanism 68 may further secure the boot 42 to the shaft 18 or inner race 44. The attachment mechanism 68 may be any one of a garter spring, band, banded clamp, eared circlip, plastic clip, etc. Various exemplary arrangements of the attachment mechanism 68 are described below.

The attachment mechanism 68 may be disposed within the boot neck 50, wherein during manufacturing of the boot neck 50 thereof, the attachment mechanism 68 may be overmolded about the attachment mechanism 68. When the boot neck 50 is slid over the shaft, the attachment mechanism 68 is configured to be sufficiently elastic such that the attachment mechanism 68 may expand just enough to allow the boot 42 to move along the shaft. Once the boot neck 50 reaches the groove 54 of the shaft, the lip 52 of the boot neck 50 may be received by the groove 54 and the attachment mechanism 68 may be configured to automatically retract and exert a radially inward force on the groove 54. In one example, the width of the attachment mechanism 68 may not exceed that of the neck 50. The width of the attachment mechanism 68 may also not exceed the width of the groove 54. This may ensure that the force exerted by the attachment mechanism 68 may be exerted within the lip/groove fit, thereby ensuring that the boot 42 is maintained about the shaft at the groove 54.

As discussed below, some of the figures show an exemplary attachment mechanism 68 being overmolded entirely within the boot 42, while others show an attachment mechanism 68 being at least partially overmolded within the boot, leaving portions of the attachment mechanism 68 exposed.

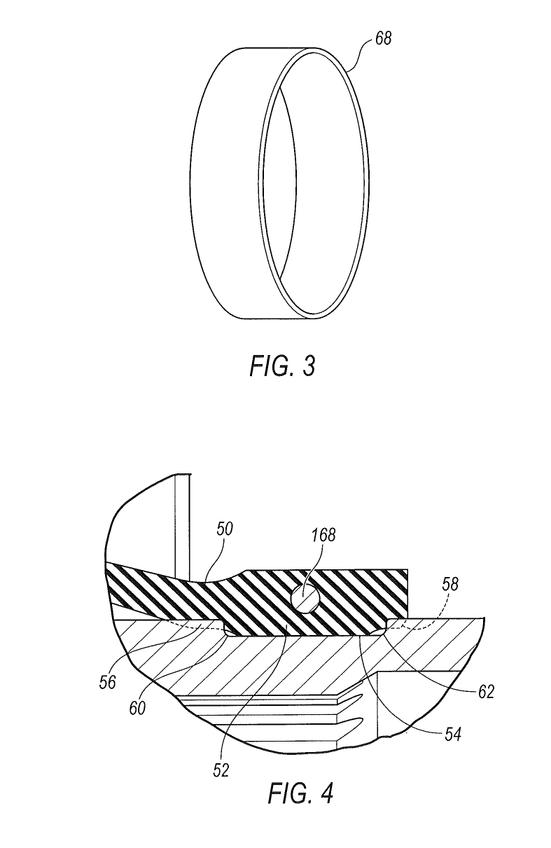

Referring to FIGS. 1-3, in the exemplary arrangement, the attachment mechanism 68 may be configured as a generally flat band that is the shape of a continuous ring (see, FIG. 3). The attachment mechanism 68 is disposed within the neck 50 of the boot 42 such that a width of the band does not exceed the width of the groove 54. As explained above, the band may expand slightly to fit around the shaft as the boot 42 is being slid towards the groove 54. Once the lip 52 of the boot neck 50 is disposed within the groove 54, the band may retract and exert a radial force on the groove 54. The attachment mechanism 68 may be made of metal, hard thermoplastic, silicone, copper, aluminum, etc.

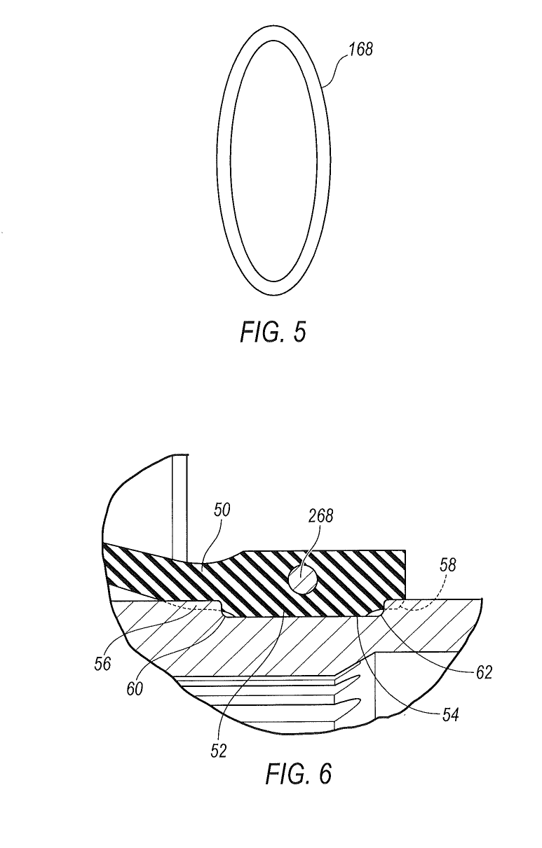

Referring to FIGS. 4-5, in the exemplary arrangement, the attachment mechanism 168 is configured as a continuous ring, whereby the boot neck 50 is overmolded around the ring. The ring may have a generally circular cross-section as shown in FIG. 4. Similar to the band described above, the ring is configured to exert a radial force on the groove to hold the boot neck 50 in the groove 54. The ring may have enough elasticity to stretch over the shaft, but retract once the lip 52 is located within the groove 54.

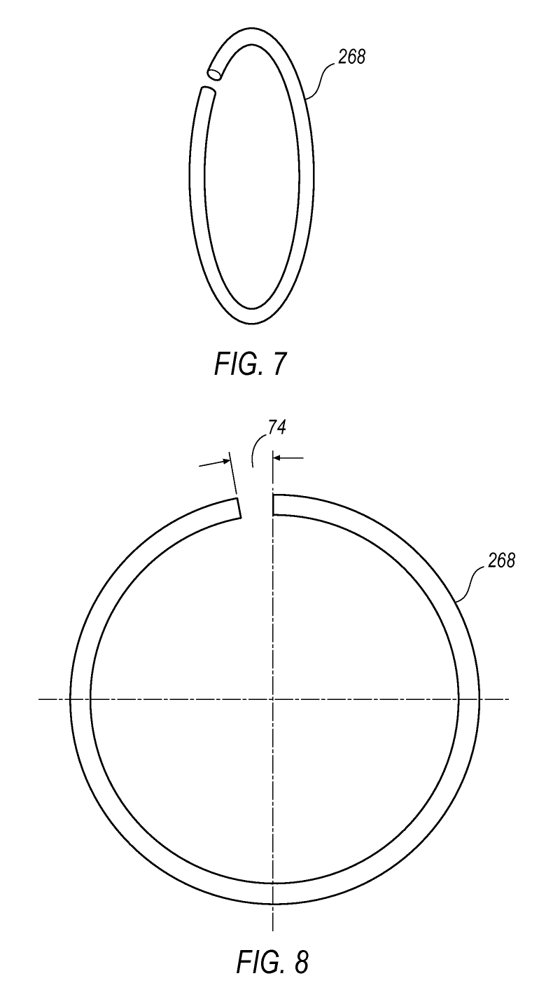

Referring to FIGS. 6-8, in the exemplary arrangement, the attachment mechanism 268 may also be configured as a ring. However, the ring 268 may be non-continuous and may be configured to define an opening 74 (best seen in FIG. 8.) Similar to the example shown in FIGS. 4-5, the boot neck 50 may be overmolded around the ring. The ring may be made out of a semi-flexible material and the opening 74 of the ring may facilitate flexibility of the ring. For example, the ring may expand, thus increasing the width of the opening 74, as the ring slides across the shaft. Once the lip 52 of the boot neck 50 reaches the groove 54 and is held therein, the width of the opening 74 may decrease, creating a radial force on the groove 54.

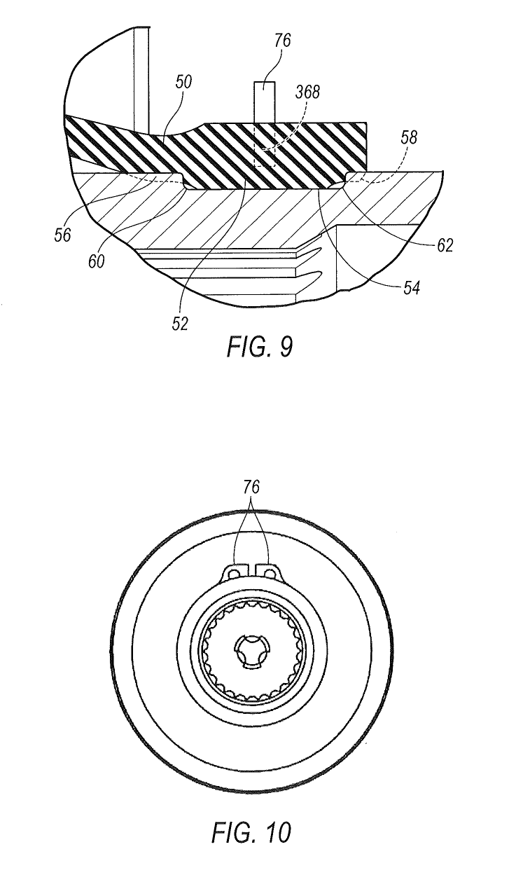

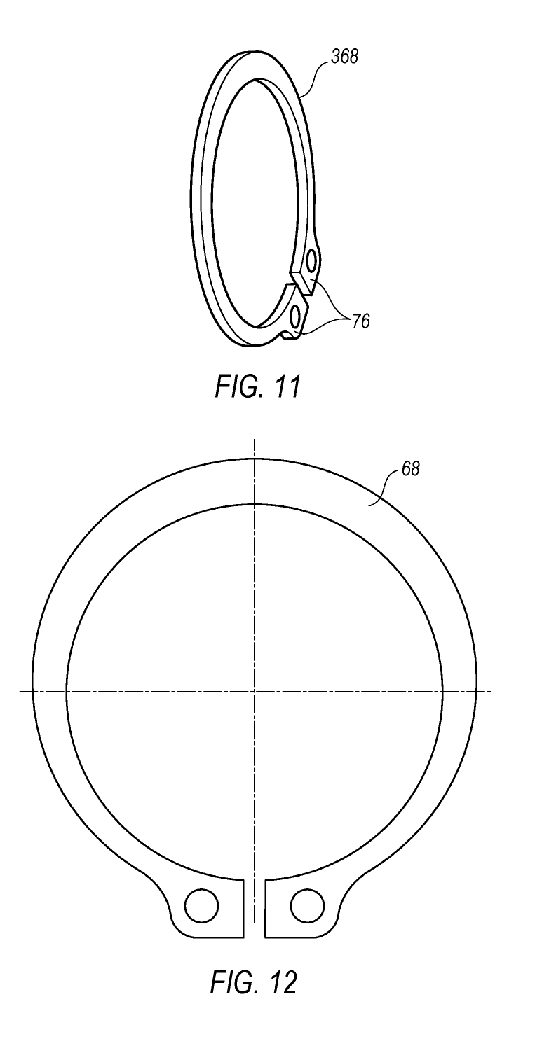

Referring to FIGS. 9-12, in the exemplary arrangement, the attachment mechanism 368 may be a circlip. The attachment mechanism 368 may also be a C-clip, snap ring, band clamp, etc. The circlip may be made of a flexible material and include two ends 76 which may be snapped, or attached together. The body, or ring, of the circlip may be overmolded within the boot neck 50, while the ends 76 may be accessible outside of the neck 50, as shown in FIGS. 9-10. Because the circlip may be made of a flexible material, the circlip may expand as the boot neck 50 is slid over the shaft. This may especially be the case if the ends 76 have not been attached to one another. Once the lip 52 of the boot neck 50 is received in the groove, the circlip may exert a radial force against the groove. Moreover, the ends of the circlip may then be snapped or attached together to further secure the boot 42 to the shaft 18 or inner race 44.

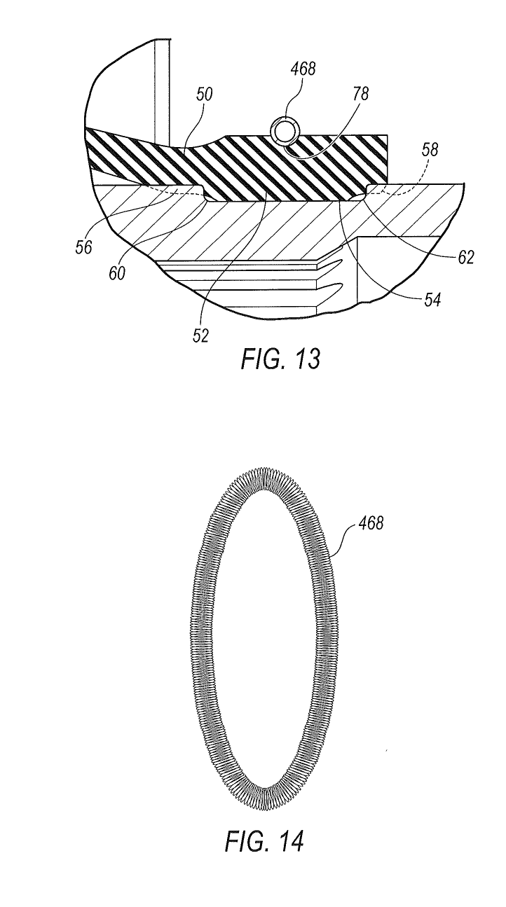

Referring to FIGS. 13-14, in the exemplary arrangement, the attachment mechanism 468 may be configured as a garter spring. The garter spring may be a coil spring attached at either end to create a ring-like shape, as shown in FIG. 14. The spring may be held within a recess 78 defined by an outside surface of the boot neck 50, as shown in FIG. 13. The boot 42 may then be overmolded over at least a portion of the spring, thus causing the spring to be integral to the boot neck 52. The spring may exert a force inward on the groove 54 when the boot lip 52 is held in the groove 54. The spring may also expand radially as the boot neck 50 is slid over the shaft. Thus, the spring, while flexible, also secures the boot lip 52 in the groove 54. Although not shown, an encasement may extend around the spring. The encasement may be made of rubber. The boot 42 may then be overmolded over at least a portion of the encasement.

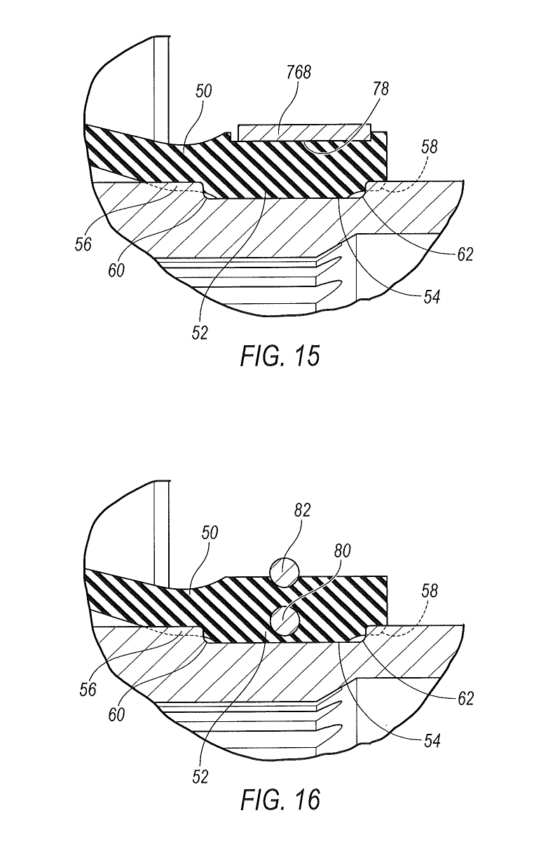

Referring to FIGS. 3 and 15, in the exemplary arrangement, the attachment mechanism 768 may be configured as a flat band extending around the neck 50 of the boot 42. While similar to the example shown in FIG. 1, the flat band of FIG. 15 may not be entirely surrounded by the boot neck 50. The band may be received by a recess defined by the outside of the boot neck 50. As explained above, the band may expand slightly to fit around the shaft 18 or inner race 44 as it is being slid towards the groove 54. Once the lip 52 of the boot neck 50 is disposed within the groove 54, the band may retract and exert a radial force on the groove 54. During manufacturing, the boot 42 may be overmolded on the band allowing the band to be integral to the boot neck 52.

Referring to FIG. 16, in the exemplary arrangement, more than one attachment mechanism may be employed and integrated within a single boot. In the example provided, a first attachment mechanism 80 and a second attachment mechanism 82 are included. In the example the first attachment mechanism 80 may be overmolded into the boot neck 50 while another attachment mechanism 82 may be only partially overmolded. The first attachment mechanism 80 may include any of the attachment mechanisms 68 described above. The second attachment mechanism 82 may be any one of the same, or may be of a different form. For example, the first attachment mechanism 80 may be a circlip, while the second attachment mechanism 82 may be a garter spring.

Thus, a CV joint having a boot and a shaft connected at a groove of the shaft via an attachment mechanism integrated into the neck of the boot is disclosed herein. By integrating the attachment mechanism into the boot before assembling the boot to the shaft, the need to attach the boot to the shaft after placement thereof via a mechanical clamp or other traditional crimping methods is eliminated.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation that is limited only by the following claims.

All terms used in the claims are intended to be given their broadest reasonable construction and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

1. A boot comprising:
a boot neck including a boot lip;
an attachment mechanism at least partially disposed within the boot neck such that the attachment mechanism is integral with the boot neck and wherein the attachment mechanism is overmolded into the boot neck;
wherein the boot lip is configured for receipt by a groove of a shaft and the attachment mechanism is configured to exert radial force on the groove to secure the boot neck to the shaft and the attachment mechanism includes an elastic property and is configured to expand before being received in the groove and to retract to exert the radial force on the shaft after the lip is received by the groove.

2. (canceled)

3. The boot of claim 1, wherein a width of the attachment mechanism does not exceed a width of the groove.

4. (canceled)

5. The boot of claim 1, wherein the attachment mechanism is entirely enclosed by the boot neck.

6. The boot of claim 1, wherein the attachment mechanism includes a first attachment mechanism and a second attachment mechanism.

7. The boot of claim 6, wherein at least one of the first and second attachment mechanisms is overmolded entirely within the boot neck and the other attachment mechanism is partially exposed at the boot neck.

8. The boot of claim 1, wherein the attachment mechanism is at least one of garter spring, ring, flat band, eared circlip, band clamp and plastic clip.

9. The boot of claim 1, wherein the attachment mechanism is non-continuous.

10. A constant velocity joint, comprising:
a shaft including a groove extending around the shaft;
a boot having a boot neck, the boot neck including a boot lip; and
an attachment mechanism disposed at least partially within the boot neck so the attachment mechanism is integrally carried by the boot neck;
wherein the groove is configured to receive the boot lip and the attachment mechanism includes an elastic property and is configured to expand before being received in the groove and to retract to exert a radial force on the shaft after the lip is received by the groove to secure the boot neck to the shaft.

11. (canceled)

12. The constant velocity joint of claim 10, wherein a width of the attachment mechanism does not exceed a width of the groove.

13. The constant velocity joint of claim 10, wherein the groove includes an inwardly sloping proximal groove wall configured to facilitate the receiving of the boot lip.

14. (canceled)

15. The constant velocity joint of claim 10, wherein the attachment mechanism is entirely enclosed by the boot neck.

16. The constant velocity joint of claim 10, wherein the attachment mechanism includes a first attachment mechanism and a second attachment mechanism.

17. The constant velocity joint of claim 16, wherein at least one of the first and second attachment mechanisms is overmolded entirely within the boot neck and the other attachment mechanism is partially exposed at the boot neck.

18. The constant velocity joint of claim 10, wherein the attachment mechanism is non-continuous.

19. The constant velocity joint of claim 10, wherein the attachment mechanism is at least one of garter spring, ring, flat band, eared circlip, band clamp and plastic clip.

20. The boot of claim 1, wherein the attachment mechanism is only partially disposed within the boot neck such that a portion of the attachment mechanism is exposed at an exterior of the boot neck.

21. The constant velocity joint of claim 10, wherein the attachment mechanism is only partially disposed within the boot neck such that a portion of the attachment mechanism is exposed at an exterior of the boot neck.

22. A boot for a constant velocity joint, comprising:
a boot neck configured to be received around a rotational member of the constant velocity joint;
an attachment mechanism partially disposed within the boot neck such that the attachment mechanism is integral with the boot neck and a portion of the attachment mechanism is exposed at an exterior of the boot neck.

23. The boot of claim 22, wherein the attachment mechanism is constructed to expand to pass over a larger portion of the rotational member and resilient to exert a radial force on a portion of the rotational member that is smaller than said larger portion.

24. The boot of claim 23 wherein the rotational member includes a groove and the attachment mechanism is configured to exert a radial force on the rotational member within the area of the groove.
